(19) United States
(12) Patent Application Publication
(10) Pub. No.: US 2026/0016148 A1
(43) Pub. Date: Jan. 15, 2026

(54) Sleep Aid Device for Children

(71) Applicant: heyaxa products INC, ANAHEIM, CA (US)

(72) Inventor: Lei XIA, ANAHEIM, CA (US)

(73) Assignee: heyaxa products INC, ANAHEIM, CA (US)

(21) Appl. No.: 18/770,660

(22) Filed: Jul. 12, 2024

(51) Int. Cl. F21V 23/04; F21V 15/01; F21V 23/02; F21V 23/06; H04R 1/02; H04R 3/00

(52) U.S. Cl. CPC F21V 23/0435; F21V 15/01; F21V 23/023; F21V 23/0485; F21V 23/06; H04R 1/025; H04R 1/028; H04R 3/00; H04R 2420/07

(57) ABSTRACT

A sleep aid device for children comprises a lamp body and a base, wherein a first circuit board and a second circuit board are respectively arranged in the lamp body and the base; the first circuit board and the second circuit board are both equipped with a single chip microcomputer and a Bluetooth control module for wireless connection with a mobile phone; the lamp body and the base are separately arranged, and an audio playing component is arranged in the base; the lamp body comprises a lampshade and a bottom plate, and the bottom plate is arranged on the lampshade and faces the base.

### TECHNICAL FIELD

The present invention relates to the technical field of children's sleeping instruments, in particular to a sleep aid device for children.

### BACKGROUND

The traditional sleeping instrument usually consists of two main parts: the top is the speaker of the sleeping instrument, and the middle or bottom is the lamp. This design makes the lamp body and the speaker integrate into one structure, which combines the functions of music playing and lighting. At night, children can fall asleep with the sleeping instrument. At the same time, the sleeping instrument can also play children's favorite music and let them enjoy soft light, thus creating a quiet and comfortable sleeping environment and enabling children to fall asleep more stably.

U.S. Patent No. US20230091548A1 discloses “MULTIFUNCTION SLEEP TRAINING DEVICE WITH REMOTE LOCKING MECHANISM AND METHODS OF OPERATION THEREOF”, which is a structure in which a lamp body and a speaker are integrated. Therefore, when a child sleeps with the sleeping instrument, the speaker will be too close to the child's ear, which will affect the child's sleep quality, and placing the speaker near the ear for a long time, especially when playing a large volume, may have a negative impact on the child's hearing.

Therefore, it is necessary to put forward a new type of children's sleeping instrument. The children sleep lamp body of this new type can be detached and placed beside children, so that the speaker is far away from children, so as to avoid affecting children's sleeping quality and hearing.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a sleep aid device for children, aiming at sol that problem that the existing children's sleep instrument is integrally provided with a speaker and a lamp body, which affects the sleep quality and hear of children.

In order to achieve the above purpose, the present invention adopts the following technical solutions:
A sleep aid device for children includes a lamp body and a base; a first circuit board and a second circuit board are respectively arranged in the lamp body and the base; and
the first circuit board and the second circuit board are both provided with a single chip microcomputer and a Bluetooth control module for wireless connection with a mobile phone; and
the lamp body and the base are separately arranged, and an audio playing component is arranged in the base; and
the lamp body comprises a lampshade and a bottom plate, wherein the bottom plate is arranged on the lampshade and faces the base, and at least one first magnet is arranged on one side of the bottom plate located inside the lampshade; and
the base comprises a shell, one surface of the shell is set as a mating surface for connecting and mating with the bottom plate, at least a second magnet is installed inside the shell, and the second magnet is attracted to the first magnet with the mating surface and the bottom plate therebetween.

A sleep aid device for children includes a lamp body and a base; the lamp body and the base are detachably connected; and
an audio playing component is arranged in the base for playing preset audio;
a first circuit board and a second circuit board are respectively arranged in the lamp body and the base; and
the first circuit board and the second circuit board are both provided with a single
chip microcomputer, a Bluetooth control module for wireless connection with a mobile phone and a WIFI module for connection with a server.

A sleep aid device for children includes a lamp body and a base; at least one base is provided, and one or more lamp bodies are provided; and
the base is detachably connected with one or more lamp bodies;
an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server.

A sleep aid device for children includes a lamp body and a base; the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board is further provided with a voice control module and a sensor lamp; and
wherein, the voice control module is used for monitoring an ambient volume, and when the ambient volume exceeds a preset value, the single chip microcomputer executes a preset program.

A sleep aid device for children includes a lamp body and a base; the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board or the second circuit board is further provided with a camera monitoring module and a sensor lamp; and
wherein, the camera monitoring module is used for monitoring a sleeping state of a child, and when it is monitored that the child wakes up within a preset time, the single chip microcomputer executes a preset program.

A sleep aid method for children includes adopting a sleep aid device for children, which comprises a lamp body and a base, wherein the lamp body and the base are detachably connected; a first circuit board and a second circuit board are respectively arranged in the lamp body and the base; the first circuit board and the second circuit board are both provided with a single chip microcomputer and a Bluetooth control module for wireless connection with a mobile phone; a voice control module and a sensor lamp are also installed on the first circuit board; and an audio playing component is arranged in the base; an outer surface of the shell is provided with a plurality of control buttons electrically connected with the second circuit board;
the method includes the following steps:
Step 1, pressing a control button to start the sleep aid device;
Step 2, using the Bluetooth function of the mobile phone to connect to the sleep aid device;
Step 3, setting a sleep plan on a mobile phone APP;
Step 4, the sleep aid device executing a sleep aid planning program;
Step 5, separating the lamp body from the base, or separating before the sleep program is executed;
Step 6, placing the lamp body beside a child to aid sleeping, and placing the base at a certain distance away from the child;
Step 7, when the child wakes up and cries, the voice control module monitoring a crying sound, and the single chip microcomputer automatically executing a preset audio and playing e the preset audio through the speaker to coax the child to continue sleeping.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the whole invention.

FIG. 2 is a schematic structural view of the lamp body of the present invention.

FIG. 3 is an exploded view of the lamp body of the present invention.

FIG. 4 is a schematic structural diagram of the base of the present invention.

FIG. 5 is an exploded view of the base of the present invention.

FIG. 6 is a control schematic diagram of the present invention.

In the figures: Lamp body (100); Lampshade (101); Bottom plate (102): First circuit board (103); First connector (104): Power module (105): First magnet (106); Light-emitting element (107): Base (200): Shell (201): Second connector (202): Control button (203): Foot pad (204); Sound outlet hole (205); Speaker (206); Second circuit board (207): Second magnet (208); Mating surface (209); Single chip microcomputer (301): WIFI module (302); First antenna (303); Audio amplifier (304): Voice control module (305); Sensor lamp (306); Second antenna (307): Bluetooth control module (309); USB interface (310).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

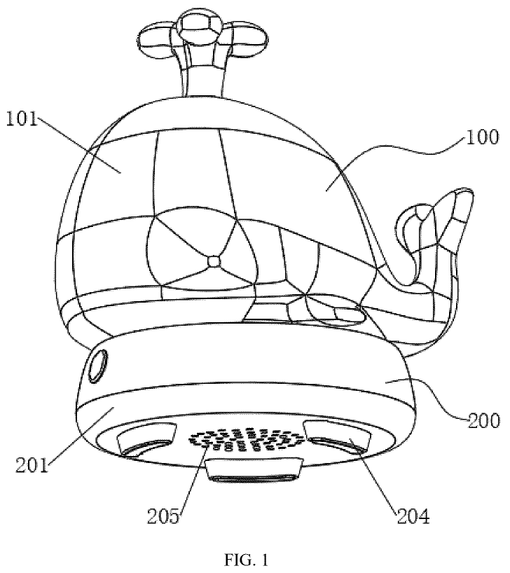

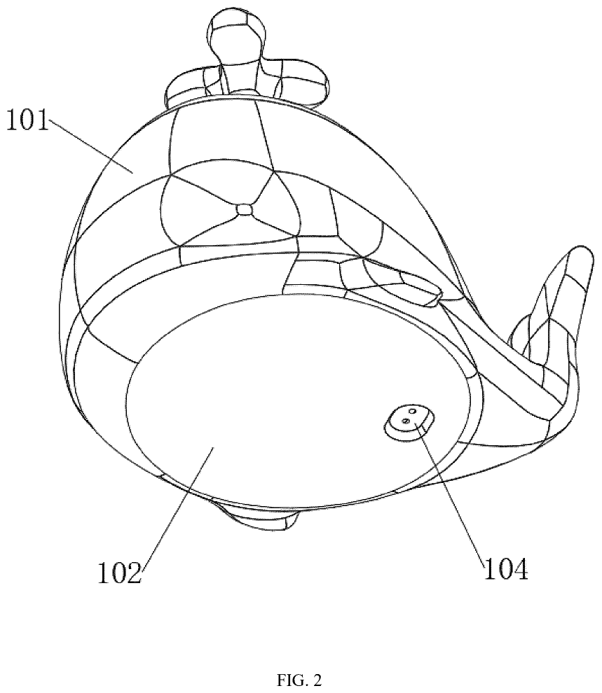

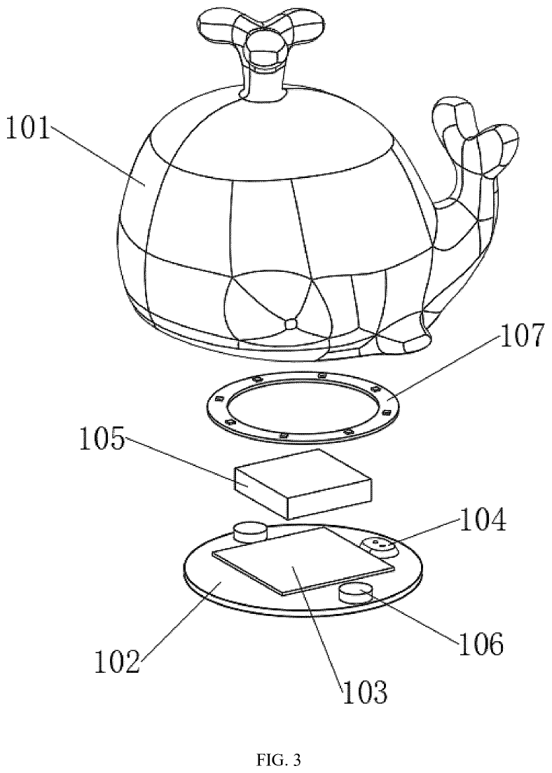

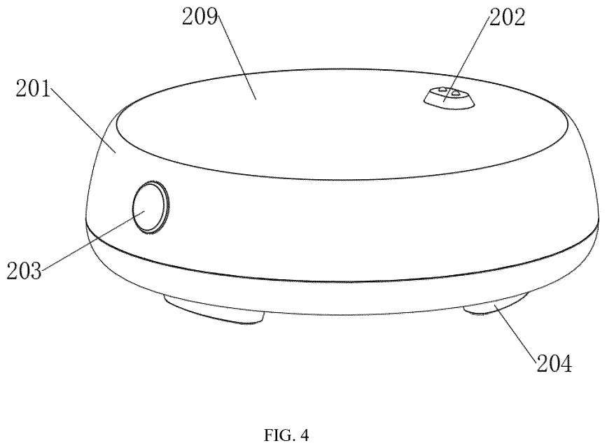

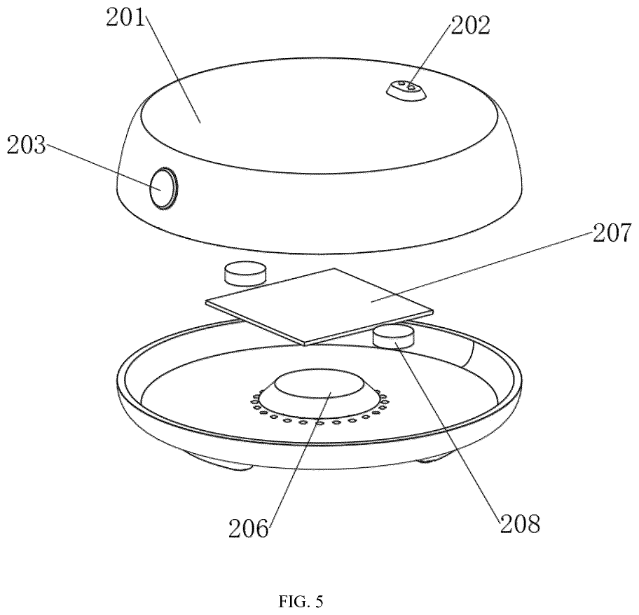

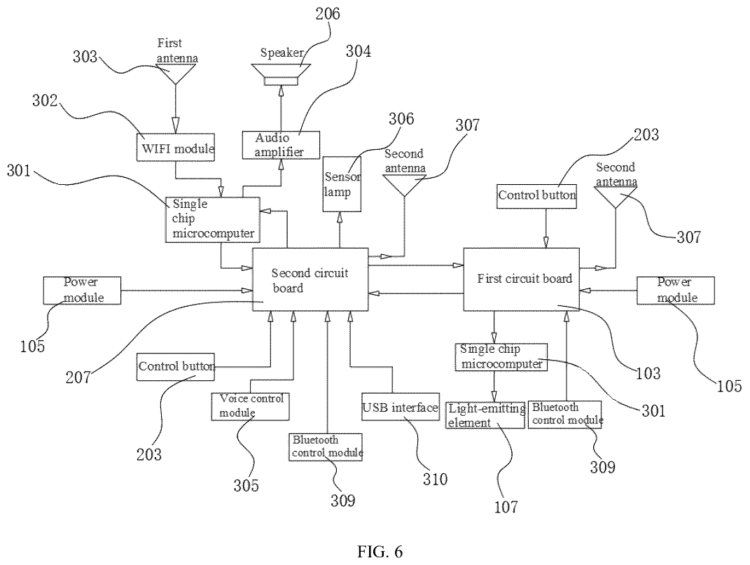

Please refer to FIG. 1 to FIG. 6;

### Example 1

The present invention provides a sleep aid device for children, which includes a lamp body 100 and a base 200, wherein a first circuit board 103 and a second circuit board 207 are respectively arranged in the lamp body 100 and the base 200; a single chip microcomputer 301 and a Bluetooth control module 309 for wireless connection with a mobile phone are arranged on the first circuit board 103 and the second circuit board 207; the lamp body 100 and the base 200 are separately arranged; and an audio playing component is arranged in the base 200.

In this embodiment, the first circuit board 103 and the second circuit board 207 can be matched and connected with the mobile phone through the Bluetooth control module 309, so that the base 200 and the lamp body 100 can be independently connected with the mobile phone, and then the lamp body 100 and the base 200 can be independently controlled through the mobile phone APP.

In other embodiments, the first circuit board 103 and the second circuit board 207 can be automatically matched and connected through Bluetooth connection, so that when a mobile phone is connected to a single lamp body 100 or the base 200, the lamp body 100 and the base 200 can be automatically matched and connected, thereby enabling data transmission between the lamp body 100 and the base 200.

The lamp body 100 includes a lampshade 101 and a bottom plate 102, wherein the bottom plate 102 is installed on the lampshade 101 and faces the base 200; at least one first magnet 106 is installed on one side of the bottom plate 102 located in the lampshade 101; the base 200 includes a shell 201; one surface of the shell 201 is set as a matching surface 209 for connecting and matching with the bottom plate 102; at least one second magnet 208 is installed inside the shell 201; the second magnet 208 is attracted to the first magnet 106 with the mating surface 209 and the bottom plate 102 therebetween. The first circuit board 103 is installed on the bottom plate 102 and staggered with the first magnet 106. The second circuit board 207 is installed on the inner surface of the shell 201 and staggered with the second magnet 208. One surface of the shell 201 is set as the mating surface 209 for connection and mating with the bottom plate 102.

In this embodiment, the first magnet 106 and the second magnet 208 are both magnets, so that when the bottom plate 102 is close to the mating surface 209 of the shell 201, the first magnet 106 and the second magnet 208 are attracted to each other being spaced by the shell 201 and the bottom plate 102, thereby quickly and firmly connecting the lamp body 100 with the lampshade 101. This structure not only simplifies the connection process, but also makes the separation between the lamp body 100 and the lampshade 101 equally convenient.

In other embodiments, one of the first magnet 106 and the second magnet 208 is a magnet and the other is a ferromagnetic material, so that attraction can also be achieved.

A power module 105 is also installed on the first circuit board 103, and at least one light-emitting element 107 electrically connected with the first circuit board 103 is installed in the lampshade 101. A side of the bottom plate 102 facing the base 200 is equipped with a first connector 104 which is electrically connected with the first circuit board 103; a second connector 202 connected with the first connector 104 is installed on the mating surface 209, and the second connector 202 is electrically connected to the second circuit board 207.

In this embodiment, the power module 105 is a storage battery, which can provide power for the first circuit board 103 and related modules. When the lamp body 100 and the base 200 are connected, the second connector 202 will be inserted into the first connector 104, so that the first circuit board 103 will be conducted with the second circuit board 207 through the connection of the first connector 104 and the second connector 202, and the battery can also supply power to the second circuit board 207 and related modules.

In this embodiment, the light-emitting element 107 is an LED circuit board, on which a plurality of lamp beads are mounted to provide a bright and uniform light source. As a stable power supply, battery can provide continuous power support for LED circuit boards. Furthermore, the single chip microcomputer 301 on the first circuit board 103 plays a core control role, which can accurately adjust the brightness and color of the light beads on the LED circuit board, bringing rich and varied lighting experiences to users. This not only ensures the stability and reliability of the light source, but also greatly improves the flexibility and convenience of use.

The audio playing component includes a speaker 206 and an audio amplifier 304.

The speaker 206 is installed on the inner surface of the shell 201 and electrically connected with the second circuit board 207. The outer surface of the shell 201 is provided with a plurality of sound outlet holes 205 corresponding to the speaker 206. The audio amplifier 304 is installed on the second circuit board 207 for amplifying the electric signal input to the speaker 206.

Audio is preset in the single chip microcomputer 301. When the sleep aid program is executed, the single chip microcomputer 301 automatically executes the preset audio, which is transmitted to the speaker 206 through the audio amplifier 304 and played out. The preset audio includes white noise, children's parents' voices and so on.

Moreover, when the mobile phone is connected with the sleep aid device by Bluetooth, the base 200 is equivalent to a Bluetooth speaker, and the audio in the mobile phone can be played through the mobile phone APP or required audio is recorded on the mobile phone APP and played, and the timbre of the children's parents can be recorded through the mobile phone APP, and then the audio that comforts the children can be played through AI combined with the timbre of the children's parents.

According to the above, the WIFI module 302 is also installed on the second circuit board 207, and the first antenna 303 is installed on the WIFI module 302. The second circuit board 207 is connected with the USB interface 310 through wires, and the USB interface 310 penetrates the outer surface of the shell 201. A plurality of control buttons 203 electrically connected with the second circuit board 207 are installed on the outer surface of the shell 201, and the foot pad 204 for supporting the base 200 is installed at the bottom of the shell 201.

In this embodiment, the base 200 is combined with the WIFI module 302 through the built-in 2.4G antenna, which realizes stable connection with the wireless network and provides users with convenient remote control and intelligent management functions. In addition, in order to facilitate the user to charge the equipment, the base 200 is also equipped with a 5V USB interface 310. The user only needs to connect an external power supply to the USB interface 310, and when the lamp body 100 is connected to the base 200, the power module 105 can be charged, thus ensuring the continuous and stable operation of the equipment.

In other embodiments, the wireless charging module can be used as the power module 105. This embodiment not only simplifies the charging process, but also improves the user experience. Users only need to put the lamp body 100 on the wireless charging base, and can charge the lamp body 100 through wireless charging without complicated cable connection, thus realizing real convenience and high efficiency.

The control button 203 is a mechanical switch or a touch switch, so the user can easily control the base 200 through the physical operation of the mechanical switch or the touch of the touch switch, and a plurality of control buttons 203 are arranged, so that each control button 203 has different functions, such as turning on or off the sleep aid device, unlocking the sleep aid device, and adjusting the light and volume. And when the base 200 and the lamp body 100 are successfully connected, the function of this control button 203 is extended due to the conduction structure between them, which can not only control various functions of the base 200, but also directly control the lamp body 100. This design not only improves the user experience, but also increases the intelligence of the equipment.

### Example 2

A sleep aid device for children includes a lamp body 100 and a base 200, wherein the lamp body 100 and the base 200 are detachably connected; an audio playing component is arranged in the base 200 for playing preset audio; a first circuit board 103 and a second circuit board 207 are respectively arranged in the lamp body 100 and the base 200; a single chip microcomputer 301 and a Bluetooth control module for wireless connection WIFI a mobile phone are installed on the first circuit board 103 and the second circuit board 207.

The difference between Example 2 and Example 1 is that:

The lamp body 100 and the base 200 can be connected by detachable connection modes such as clamping, threaded connection and the like. The first circuit board 103 is further provided with a voice control module 305 and a sensor lamp 306. The voice control module 305 is used for monitoring the ambient volume, and the sensor lamp 306 is automatically turned on when the ambient volume exceeds a preset value. The first circuit board 103 and the second circuit board 207 are both provided with a second antenna 307 for data transmission between the first circuit board 103, the second circuit board 207 and the mobile phone.

The voice control module 305 can monitor the ambient volume, and can monitor the ambient volume in real time and compare it with the preset sound decibel value. Once the monitored decibel value exceeds the preset value, the voice control module 305 will automatically start the sensor lamp 306 to provide users with real-time lighting services, and at the same time, the single chip microcomputer 301 will automatically play the preset audio or adjust the light of the lamp body 100. This method not only improves the intelligent level of the equipment, but also brings users a more convenient experience.

By setting the second antenna 307, when the mobile phone is connected with the second circuit board 207 through the wireless network, the first circuit board 103 and the second circuit board 207 can be wirelessly connected through the two second antennas 307, thereby realizing wireless data transmission among the base 200, the lamp body 100 and the mobile phone. This method not only expands the functional scope of the equipment, but also provides users with more diverse usage scenarios.

### Example 3

The difference between Embodiment 3 and Embodiment 2 is that there is at least one base 200 and one or more lamp bodies 100. The base 200 is detachably connected WIFI one or more lamp bodies 100, and an audio playing component is arranged in the base 200 for playing preset audio. The first circuit board 103 and the second circuit board 207 are respectively arranged in the lamp bodies 100 and the base 200, and the first circuit board 103 and the second circuit board 207 are both equipped with a single chip microcomputer 301, a Bluetooth control module 309 for wireless connection with a mobile phone, and a WIFI module 302 for connection with a server.

The Bluetooth control module 309 of the base 200 can be matched and connected with the mobile phone, while a plurality of lamp bodies 100 can be matched and connected with the base 200 through the Bluetooth control module 309, and a plurality of lamp bodies 100 are also matched and connected with each other through the Bluetooth control module 309. Therefore, in this way, when the mobile phone is connected with the base 200, all the lamp bodies 100 can be controlled.

Moreover, in this embodiment, a plurality of lamp bodies 100 can be detachably attached to the base 200, and at the same time, a plurality of lamp bodies 100 can also be detached from the base 200 and placed at required positions respectively.

Moreover, in this embodiment (not shown in the attached drawings), the layout of the audio playing component is not limited to the installation inside the base 200. In fact, the audio playing component can also be installed in the lamp body 100 by the technical means of Example 1, thus endowing the lamp body 100 with the function of audio playing in addition to lighting.

Therefore, in this way, the lamp body 100 with the audio playing component is placed in the required place, so that a more stereoscopic sound effect and an all-round lighting environment can be achieved, and sound and light can be prevented from emitting from one point, thus making the sleeping environment of children more comfortable.

Moreover, in this embodiment, the color and shape of each lamp body 100 are different, so in this way, the styles of the lamp bodies 100 can be replaced according to the children's favorite, so as to be combined into sleep aid devices with different styles, and the applicability of the sleep AIDS is improved.

### Example 4

The difference between Example 4 and Example 3 lies in that the lamp body 100 is installed on the base 200, and an audio playing component is arranged in the base 200 for playing preset audio, and the first circuit board 103 and the second circuit board 207 are respectively arranged in the lamp body 100 and the base 200, and a single chip microcomputer 301 and a Bluetooth control module 309 for wireless connection with a mobile phone are installed on both the first circuit board 103 and the second circuit board 207; the first circuit board 103 is further provided WIFI a voice control module 305 and a sensor lamp 306; the voice control module 305 is used for monitoring the ambient volume, and when the ambient volume exceeds a preset value, the single chip microcomputer 301 executes a preset program.

In this embodiment, the lamp body 100 and the base 200 can be connected in a non-detachable or detachable way, so that the sleep aid device for children also has the function of monitoring the ambient volume. When the ambient volume is greater than the preset value, the children's sleep aid device can automatically execute preset programs, such as playing preset audio and adjusting the lighting.

### Example 5

The difference between Example t 5 and Example 4 is that the first circuit board 103 or the second circuit board 207 is also equipped with a camera monitoring module and a sensor lamp 306 (not shown in the attached figure). In other embodiments, both the first circuit board 103 and the second circuit board 207 can also be provided with a camera monitoring module and a sensor lamp 306.

The camera monitoring module can shoot children and capture their active state. When children are in active state, it indicates that children have woken up. Therefore, when it is monitored that the child wakes up within the preset time, the single chip microcomputer 301 executes the preset program.

The present invention also provide a sleep aid method for children, which include that following steps: adopting a sleep aid device for children, wherein the device includes a lamp body 100 and a base 200, and the lamp body 100 and the base 200 are detachably connected; a first circuit board 103 and a second circuit board 207 are respectively arranged in the lamp body 100 and the base 200; the first circuit board 103 and the second circuit board 207 are both equipped with a single chip microcomputer 301 and a Bluetooth control module 309 for wireless connection with a mobile phone; a voice control module 305 and a sensor lamp 306 are also installed on the first circuit board 103, an audio playing component is arranged in the base 200, and a plurality of control buttons 203 electrically connected with the second circuit board are installed on the outer surface of the shell;
the method includes the following steps:
Step 1, pressing the control button 203 to start the sleep aid device, and the sleep aid device executing the sleep aid program; at the same time, after the sleep aid device is started, the control button 203 automatically entering a self-locking state, so as to prevent children from accidentally touching the control button 203 and causing the sleep aid device to close;
Step 2, using the Bluetooth function of the mobile phone to be connected to the sleep aid device; after the mobile phone is connected to the sleep aid device, regulating the volume and brightness of the sleep aid device through the mobile APP;
Step 3, setting a sleep plan on the mobile app; after the appropriate sleep program is set, locking the sleep aid device by one button or turning off the self-locking of the control button 203 by the mobile phone APP; if it is necessary to adjust the sleep plan, long-pressing one of the control buttons on the base 200 to unlock all the control buttons 203 on the device, and adjusting the light and sound by the control buttons 203, or terminating the sleep planning program; the user can also adjust the sleep plan through the mobile phone APP.
Step 4, the sleep aid device executing the sleep aid planning program;
Step 5, separating the lamp body 100 and the base 200; at the same time, connecting the base 200 to an external power supply through the USB interface 310 for power supply; they can also be separated before the sleep program is executed;
Step 6, placing the lamp body 100 next to the child to aid sleeping, and placing the base 200 at a certain distance away from the child; at the same time, the speaker 206 on the base 200 playing preset music to help children sleep.
Step 7, when the child wakes up and cries, the voice control module 305 monitoring the crying sound, and the single chip microcomputer 301 automatically executing the preset audio or the recorded audio, and then playing it through the speaker 206, thus coaxing the child to continue sleeping.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A sleep aid device for children, comprising a lamp body and a base, wherein,
a first circuit board and a second circuit board are respectively arranged in the lamp body and the base; and
the first circuit board and the second circuit board are both provided with a single chip microcomputer and a Bluetooth control module for wireless connection with a mobile phone; and
the lamp body and the base are separately arranged, and an audio playing component is arranged in the base; and
the lamp body comprises a lampshade and a bottom plate, wherein the bottom plate is arranged on the lampshade and faces the base, and at least one first magnet is arranged on one side of the bottom plate located inside the lampshade; and
the base comprises a shell, one surface of the shell is set as a mating surface for connecting and mating with the bottom plate, at least a second magnet is installed inside the shell, and the second magnet is attracted to the first magnet with the mating surface and the bottom plate therebetween.

2. The sleep aid device for children according to claim 1, wherein the first circuit board is installed on the bottom plate and staggered with the first magnet, and the second circuit board is installed on an inner surface of the shell and staggered with the second magnet.

3. The sleep aid device for children according to claim 1, wherein the first circuit board is further provided with a power module, and at least one light-emitting element electrically connected with the first circuit board is installed in the lampshade.

4. The sleep aid device for children according to claim 1, wherein a first connector is installed on one side of the bottom plate facing the base, and the first connector is electrically connected with the first circuit board.

5. The sleep aid device for children according to claim 4, wherein one surface of the shell is set as a mating surface for connecting and mating with the bottom plate, a second connector connected with the first connector is installed on the mating surface, and the second connector is electrically connected with the second circuit board.

6. The sleep aid device for children according to claim 1, wherein the audio playing component comprises a speaker and an audio amplifier, and the speaker is installed on the inner surface of the shell and electrically connected with the second circuit board.

7. The sleep aid device for children according to claim 6, wherein an outer surface of the shell is provided with a plurality of sound outlet holes corresponding to the speaker, and the audio amplifier is installed on the second circuit board for amplifying electrical signals input to the speaker.

8. The sleep aid device for children according to claim 1, wherein a WIFI module is further installed on the second circuit board, and a first antenna is installed on the WIFI module.

9. The sleep aid device for children according to claim 1, wherein the second circuit board is connected with a USB interface through a wire, and the USB interface penetrates through the outer surface of the shell.

10. The sleep aid device for children according to claim 1, wherein a plurality of control buttons electrically connected with the second circuit board are installed on the outer surface of the shell, and a foot pad for supporting the base is installed at a bottom of the shell.

11. A sleep aid device for children, comprising a lamp body and a base, wherein,
the lamp body and the base are detachably connected; and
an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server.

12. The sleep aid device for children according to claim 11, wherein the first circuit board is further provided with a voice control module and a sensor lamp, the voice control module is used for monitoring an ambient volume, and when the ambient volume exceeds a preset value, the single chip microcomputer executes a preset program.

13. A sleep aid device for children, comprising a lamp body and a base, wherein,
at least one base is provided, and one or more lamp bodies are provided; and
the base is detachably connected with one or more lamp bodies;
an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server.

14. A sleep aid device for children, comprising a lamp body and a base, wherein,
the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board is further provided with a voice control module and a sensor lamp; and
wherein, the voice control module is used for monitoring an ambient volume, and when the ambient volume exceeds a preset value, the single chip microcomputer executes a preset program.

15. A sleep aid device for children, comprising a lamp body and a base, wherein,
the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board or the second circuit board is further provided with a camera monitoring module and a sensor lamp; and
wherein, the camera monitoring module is used for monitoring a sleeping state of a child, and when it is monitored that the child wakes up within a preset time, the single chip microcomputer executes a preset program.

16. A sleep aid method for children, comprising adopting a sleep aid device for children, which comprises a lamp body and a base, wherein the lamp body and the base are detachably connected; a first circuit board and a second circuit board are respectively arranged in the lamp body and the base; the first circuit board and the second circuit board are both provided with a single chip microcomputer and a Bluetooth control module for wireless connection with a mobile phone; a voice control module and a sensor lamp are also installed on the first circuit board; and an audio playing component is arranged in the base; an outer surface of the shell is provided with a plurality of control buttons electrically connected with the second circuit board; and
the method comprises the following steps:
Step 1, pressing a control button to start the sleep aid device;
Step 2, using the Bluetooth function of the mobile phone to connect to the sleep aid device;
Step 3, setting a sleep plan on a mobile phone APP;
Step 4, the sleep aid device executing a sleep aid planning program;
Step 5, separating the lamp body from the base, or separating before the sleep program is executed;
Step 6, placing the lamp body beside a child to aid sleeping, and placing the base at a certain distance away from the child;
Step 7, when the child wakes up and cries, the voice control module monitoring a crying sound, and the single chip microcomputer automatically executing a preset audio and playing e the preset audio through the speaker to coax the child to continue sleeping.

17. The sleep aid method for children according to claim 16, wherein after the mobile phone is connected with the sleep aid device, the mobile phone APP is used to regulate the volume and brightness of the sleep aid device, replace or interrupt the sleep aid program.

18. The sleep aid method for children according to claim 17, wherein after an appropriate sleep program is set, the sleep aid device is locked by one key through the mobile phone APP to prevent the child from accidentally touching the control button to cause the sleep aid device to close.

19. The sleep aid method for children according to claim 18, wherein when the sleep plan needs to be adjusted, all the control buttons on the device can be unlocked by long pressing one of the control buttons, and the light and sound levels can be adjusted by the control buttons, or the sleep planning program can be terminated.
